(19) United States
(12) Patent Application Publication
(10) Pub. No.: US 2025/0150384 A1
(43) Pub. Date: May 8, 2025

(54) SWITCH CONTROLLER, SENDING CONTROLLER AND METHODS FOR USE IN SWITCH CONTROLLER AND SENDING CONTROLLER

(71) Applicant: HUAWEI TECHNOLOGIES CO., LTD., Shenzhen (CN)

(72) Inventors: Reuven Cohen, Hod Hasharon (IL); Ben-Shahar Belkar, Hod Hasharon (IL); Tal Mizrahi, Hod Hasharon (IL); Yoni Bick, Hod Hasharon (IL); Amir Roitshtein, Hod Hasharon (IL)

(73) Assignee: HUAWEI TECHNOLOGIES CO., LTD., Shenzhen (CN)

(21) Appl. No.: 18/952,980

(22) Filed: Nov. 19, 2024

Related U.S. Application Data
(63) Continuation of application No. PCT/EP2022/063695, filed on May 20, 2022.

(51) Int. Cl. H04L 45/00; H04L 5/00; H04L 45/24

(52) U.S. Cl. CPC H04L 45/22; H04L 5/0055; H04L 45/24

(57) ABSTRACT

A switch controller, where the switch controller includes a processor that is configured to: receive a multicast packet from a sender, where the multicast packet includes a header and a payload, determine that an attempt to forward the multicast packet through one or more ports fails for at least one of the one or more ports, determine that a header-forwarding bit in the header is set, and send the header of the multicast packet to the sender.

### CROSS-REFERENCE TO RELATED APPLICATIONS

This application is a continuation of International Application No. PCT/EP2022/063695, filed on May 20, 2022, the disclosure of which is hereby incorporated by reference in its entirety.

### FIELD

The present disclosure relates generally to the field of distributed computing and more specifically, to a switch controller, a sending controller, a method for use in the switch controller, and a method for use in the sending controller, for preventing negative acknowledgment storm in reliable multicast communications.

### BACKGROUND

In today's world, sharing information rapidly to multiple receivers becomes a basic requirement of many applications. Therefore, multicast communication is one of the more popular ways of sending information from one source to multiple receivers. In multicast communication, the same message is sent to multiple receivers. Multicast communication is used in many applications such as distributed machine learning training, streaming media, and the like.

Generally, an internet protocol (IP) multicast is considered as a partially efficient way to send a same IP packet to multiple receivers. In IP multicast, a multicast tree is formed between network switches and the multicast tree covers a number of receivers. Thereafter, each IP packet is forwarded over the multicast tree and by doing this the IP packet reaches a number of receivers. The IP multicast is comparatively more efficient than unicast communication in which an individual copy of each IP packet is sent to each receiver over a shortest path between a sender and a receiver. However, during transmission of IP packets in computer networks, one or more IP packets may “get lost” before reaching their respective destinations. The loss of one or more IP packets is mainly due to network congestion. In order to ensure that each IP packet reaches its respective destination group, one or more protocols are used such as a reliable multicast protocol. In the reliable multicast protocol, a first copy of each IP packet is usually sent over the multicast tree using the IP multicast. If the first copy of each IP packet is not received by all the receivers, then each receiver would send a negative acknowledgement (NACK) message to the sender. Therefore, there might be a storm of multiple NACK messages provided to the sender from receivers that do not receive the first copy of each IP packet. These NACK messages may cause a congestion on the path to the sender and consume a significant portion of the sender's processing power. As a result, there exists a technical problem of how to efficiently prevent the storm of NACK messages provided to the sender in a reliable multicast protocol in order to achieve a reduction in the network load at the sender, and saving network bandwidth.

Therefore, in light of the foregoing discussion, there exists a need to overcome the aforementioned drawbacks associated with the conventional ways of using the reliable multicast protocol.

### SUMMARY

The present disclosure provides a switch controller and a sending controller. The disclosure further provides a method for use in the switch controller and a method for use in the sending controller. The present disclosure provides a solution to the existing problem of how to prevent the storm of negative acknowledgement messages at the sender in the reliable multicast protocol. The present disclosure provides a solution that overcomes the problems encountered in the prior art and provides an improved switch controller, an improved sending controller, and improved methods for use in the improved switch controller, and the improved sending controller in order to prevent the storm of negative acknowledgement messages at a sender in a reliable multicast protocol.

In one aspect, the present disclosure provides a switch controller. The switch controller is configured to receive a multicast packet from a sender, wherein the multicast packet comprises a header and a payload, and an attempt to forward the multicast packet through one or more ports is made. The switch controller is further configured to determine that the attempt to forward the multicast packet fails for at least one of the one or more ports, and in response thereto determine that a header-forwarding bit in the header is set, and in response thereto send the header of the multicast packet to the sender.

Beneficially, use of the switch controller enables the transmission of the multicast packet to multiple receivers through the one or more ports. Furthermore, the switch controller determines if the attempt to forward the multicast packet fails for the at least one of the one or more ports. In response to determination of failure of the attempt, the switch controller determines the status of the header forwarding bit in the header. If the switch controller finds the status of the header forwarding bit as set in the header, then the switch controller sends the header back to the sender. In this way, the switch controller prevents a storm of negative acknowledgement messages at the sender by virtue of sending back merely the header of the multicast packet to the sender. This further results into saving of network bandwidth and reducing the network load at the sender. Moreover, due to prevention of the storm of negative acknowledgement messages at the sender, the consumption of the sender's processing power is significantly reduced. Additionally, the end-to-end latency in communication of the multicast packet is significantly reduced. The switch controller may be used for next generation remote direct memory access (RDMA) protocols offloading on a Smart network interface card (NIC). Thus, the switch controller provides a system solution instead of a single point solution.

In an implementation form, the switch controller is further configured to determine which port failed and include an indication of this port in the header before sending the header to the sender.

It is advantageous to include the indication in the header about the port that failed in forwarding the multicast packet so that the sender may receive the information about the corresponding port and may perform a reliable communication with the receiver that is connected by the corresponding port.

In a further implementation form, the switch controller is further configured to determine a number of how many ports failed and include an indication of this number of failed ports in the header before sending the header to the sender.

It is advantageous to include the indication in the header about the number of ports that failed in forwarding the multicast packet so that the sender may decide how to ensure reliable multicast.

In a further implementation form, the switch controller is further configured to determine a number of hops traversed by the received multicast packet and include an indication of this number of hops in the header before sending the header to the sender.

It is advantageous to include the indication in the header about the number of hops traversed by the received multicast packet so that the sender receives an exact count of the hops traversed by the received multicast packet and decide how to ensure reliable multicast.

In a further implementation form, the switch controller is further configured to set the header-forwarding bit in the header before sending the header to the sender to indicate that the header is a failed multicast packet header.

It is advantageous to set the header-forwarding bit in the header before sending the header to the sender because the header-forwarding bit helps in providing an acknowledgment to the sender about the failed multicast packet. The acknowledgment helps the sender in performing a reliable communication.

In a further implementation form, the switch controller is further configured to determine that a second header-forwarding bit is set, and if so, attempt to send the header through the failed port.

It is advantageous to set the second header-forwarding bit in the header that notifies the switch controller to send only the header through the failed port to a receiver so that the receiver receives a notification about the failed attempt of forwarding the multicast packet, and the receiver sends a negative acknowledgment (NACK) message to the sender without waiting for a time-out. Moreover, the sender notifies the switch controller to send the header through the failed port after analysing that the number of failed ports is very few so the NACK messages will be very few.

In another aspect, the present disclosure provides a sending controller configured to generate a multicast packet, where the multicast packet includes a header and a payload, set a header-forwarding bit in the header, and transmit the multicast packet.

The sending controller is configured to generate the multicast packet that is beneficial in sharing information rapidly with multiple receivers and the generated multicast packet includes the header and the payload. The payload is the information stored in the multicast packet, and the header is an attachment of the multicast packet, where the header is detachable according to the requirement. Further, the multicast packet is forwarded with the set header-forwarding bit in the header that helps in sending the header back to the sending controller upon failure of the attempt to forward the multicast packet to at least one receiver.

In an implementation form, the sending controller is further configured to receive the header as a response and determine that a multicast transmission has failed.

It is advantageous to receive the header by the sending controller because reception of the header acknowledges the sending controller that the transmission of multicast packet has failed.

In a further implementation form, the sending controller is further configured to retransmit the multicast packet as a multicast and receive the header as a response. The sending controller is further configured to receive one or more NACK-messages from corresponding receivers and retransmit the multicast packet as a unicast packet to each of the corresponding receivers.

By virtue of receiving the header first time, the sending controller retransmits the multicast packet as the multicast, so the multicast packet is retransmitted to multiple receivers. Further, the sending controller again receives the header which provides acknowledgment to the sending controller that the transmission of the multicast packet has failed again. The receivers which didn't receive the multicast packet also in the second attempt, send the NACK-message to the sending controller. The sending controller performs the transmission a third time but in such a scenario the sending controller transmits the unicast packet separately to the corresponding receiver instead of transmitting the multicast packet as the multicast.

In a further implementation form, the sending controller is further configured to retransmit the multicast packet as a multicast and setting a second header-forwarding bit in the header, and receive the header as a response. The sending controller is further configured to receive one or more NACK-messages from corresponding receivers and retransmit the multicast packet as a unicast packet to each of the corresponding receivers.

It is advantageous to set the second header-forwarding bit in the header before retransmitting the multicast packet as the multicast, as the second header-forwarding bit notifies a switch controller to send the header to a receiver who did not receive multicast packet so that the respective receiver receives the acknowledgment about the failed attempt of forwarding the multicast packet, and sends the NACK-messages to the sending controller.

In a yet another aspect, the present disclosure provides a method for use in a switch controller. The method includes receiving a multicast packet from a sender, wherein the multicast packet comprises a header and a payload, and attempting to forward the multicast packet through one or more ports. The method further includes determining that the attempt to forward the multicast packet fails for at least one of the one or more ports, and in response thereto determining that a multicast bit in the header is set, and in response thereto sending the header of the multicast packet to the sender.

The method achieves all the advantages and technical effects of the switch controller of the present disclosure.

In a yet another aspect, the present disclosure further provides, a method for use in a sending controller. The method includes generating a multicast packet, where the multicast packet comprises a header and a payload, setting a header-forwarding bit in the header, and transmitting the multicast packet.

The method achieves all the advantages and technical effects of the sending controller of the present disclosure.

It should be apparent that all devices, elements, circuitry, units and means described in the present disclosure could be implemented in the software or hardware elements or any kind of combination thereof. All steps which are performed by the various entities described in the present disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a network diagram that illustrates communication of a multicast packet using a switch controller, in accordance with an embodiment of the present disclosure:

FIG. 2 is a block diagram that illustrates various exemplary components of a switch controller, in accordance with an embodiment of the present disclosure:

FIG. 3 is a flow chart of a method for use in a switch controller, in accordance with an embodiment of the present disclosure:

FIG. 4 is a block diagram of a sending controller, in accordance with an embodiment of the present disclosure:

FIG. 5 is a block diagram that illustrates various exemplary components of a sender, in accordance with an embodiment of the present disclosure; and

FIG. 6 is a flow chart of a method for use in a sending controller, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

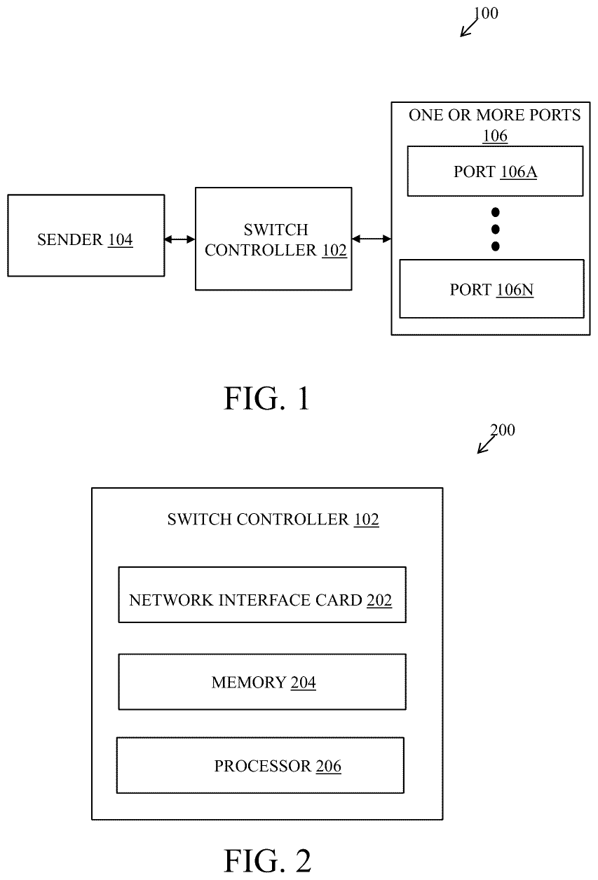

FIG. 1 is a network diagram that illustrates communication of a multicast packet using a switch controller, in accordance with an embodiment of the present disclosure. With reference to the FIG. 1, there is shown a network diagram 100 that includes a switch controller 102, a sender 104, and one or more ports 106. The one or more ports 106 includes a first port 106A up to Nth port 106N.

The switch controller 102 may include suitable logic, circuitry, interfaces, or code that is configured to receive a multicast packet from a source and transfer the corresponding multicast packet to multiple receivers. Further, the switch controller 102 also provides acknowledgement to the source if the multicast packet does not reach to at least one of the multiple receivers by sending a header to the source. Example of the switch controller 102 is when a broadcast message is sent from a mobile device then the broadcast message firstly goes to a nearby mobile switching centre and further transmitted to the multiple receivers selected by the mobile device. In this scenario, the mobile switching centre is the switch controller 102. In an implementation, the switch controller 102 may be either a software module or a hardware module (e.g., a router) or a combination of the software module and the hardware module.

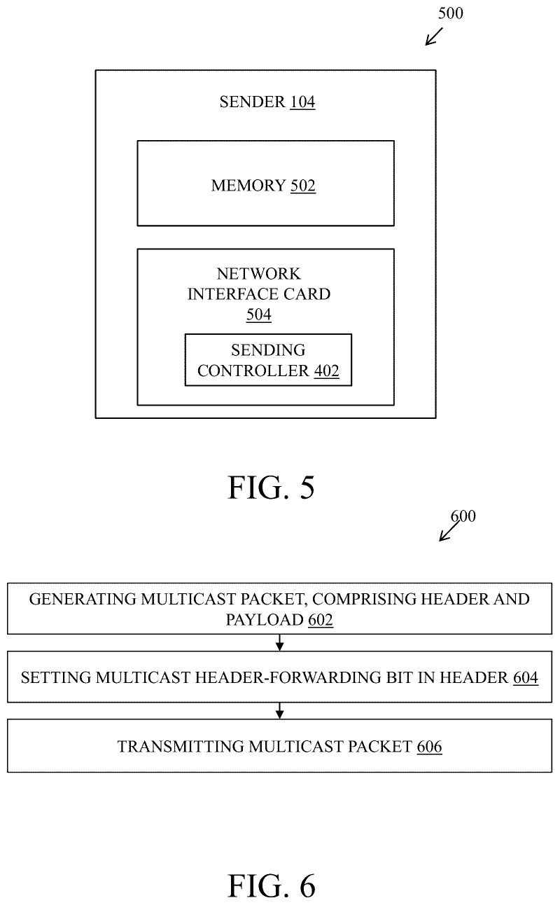

The sender 104 may include suitable logic, circuitry, interfaces, or code that is configured to generate the multicast packet to transfer information to the multiple receivers. Further, the sender 104 firstly forwards the multicast packet to the switch controller 102 which further transmits the multicast packet to each receiver. An example of a sender 104 is when a message is sent from a mobile device or a computer to another device then the mobile device or the computer that is sending the message is considered as the sender 104. The sender 104 is described in more detail, for example, in FIG. 5.

The one or more ports 106 may include suitable logic, circuitry, interfaces, or code that is configured to carry the multicast packet from the switch controller 102 to the multiple receivers.

In operation the switch controller 102 is configured to receive a multicast packet from the sender 104 and the multicast packet includes a header and a payload. The multicast packet is received by the switch controller 102 from the sender 104 to forward the corresponding multicast packet to the multiple receivers through the one or more ports 106. The switch controller 102 acts as a mediator for performing the task of sending the multicast packet from the sender 104 to the multiple receivers. For example, to send the multicast packet to the multiple receivers, the sender 104 firstly forwards the multicast packet to the switch controller 102 then the corresponding multicast packet is transferred to the receivers by the switch controller 102 through the one or more ports 106. Further, the multicast packet is divided in two parts, one is the header, and another is the payload. The header is a detachable part that can be used for acknowledgment purpose and the payload contains the main information which is required to be sent to the multiple receivers.

The switch controller 102 is configured to attempt to forward the multicast packet through the one or more ports 106. After receiving the multicast packet, the switch controller 102 forwards the multicast packet to the multiple receivers through the one or more ports 106. The one or more ports 106 provides a path to the switch controller 102 for sending the multicast packet to the receivers, as the one or more ports 106 are connected to the multiple receivers which helps the switch controller 102 in forwarding the multicast packet to the multiple receivers. For example, to send the multicast packet to the multiple receivers, the switch controller 102 firstly forwards the multicast packets to the one or more ports 106 and then the corresponding multicast packet is transferred to the multiple receivers.

The switch controller 102 is configured to determine that the attempt to forward the multicast packet fails for at least one of the one or more ports 106. In an example, the multicast packet is forwarded by the switch controller 102 to the multiple receivers through the one or more ports 106 and the task of forwarding the multicast packet fails for at least one of the one or more ports 106 then the switch controller 102 acts according to the situation, described later in the disclosure.

In response to the failure in forwarding the multicast packet, the switch controller 102 determine that a header-forwarding bit in the header is set. The multicast packet includes address of its destination. Further, the address of the destination also discloses that the packet is the multicast packet. Further, the header is one of the parts of the multicast packet and the header-forwarding bit is set in the header. The header-forwarding bit is stored with an instruction which is followed by the switch controller 102 upon failure of forwarding the multicast packet.

In response to the determination of the header-forwarding bit is set in the header, the switch controller 102 is configured to send the header of the multicast packet to the sender 104. For example, if the multicast packet forwarded by the switch controller 102 has failed to reach to the at least one of the one or more ports 106 then the switch controller 102 follows the instruction stored in the header-forwarding bit and sends the header of the failed multicast packet back to the sender 104, respectively. Moreover, the switch controller 102 receives the multicast packet from the sender 104 through a first path and sends the header to the sender 104 through a second path. Further, the first path is not same as the second path. The sender 104 receives the header that notifies to the sender 104 about failure of the task of forwarding the multicast packet to the at least one of the multiple receivers.

In accordance with an embodiment, the switch controller 102 is further configured to determine which port failed and include an indication of corresponding port in the header before sending the header to the sender 104. The multicast packet is forwarded from the one or more ports 106 and if the first port 106A fails to forward the multicast packet then, the switch controller 102 is configured to truncate the header of the multicast packet which is forwarded from the first port 106A. Further, the switch controller 102 provides the indication in the header about the first port 106A to notify the sender 104 that the first port 106A fails to forward the multicast packet. In an implementation, the one or more ports 106 may fail to forward the multicast packets, in such a scenario the switch controller 102 truncates the headers of the multicast packets forwarded from the one or more ports 106. The switch controller 102 provides the indication in the headers about the one or more ports 106 to notify the sender 104 that the one or more ports 106 which failed to forward the multicast packets.

In accordance with an embodiment, the switch controller 102 is further configured to determine a number of how many ports failed and include an indication of this number of failed ports in the header before sending the header to the sender 104. The multicast packet is forwarded from the one or more ports 106 and the switch controller 102 provides the indication of the number of ports that are failed to forward the multicast packet, and the indication is included in the header that is sent back to the sender 104. For example, in a scenario where the multicast packet is forwarded from the one or more ports 106 and ten ports have failed to forward the multicast packet, then the switch controller 102 truncates the header of the multicast packet which is forwarded from the corresponding ten ports. The switch controller 102 provides the indication in the header about the corresponding ten ports which failed to forward the multicast packet and sends the respective header to the sender 104.

In accordance with an embodiment, the switch controller 102 is further configured to determine a number of hops traversed by the received multicast packet and include an indication of this number of hops in the header before sending the header to the sender 104. Before reaching the receivers, the multicast packet is traversed through the number of hops. For example, the multicast packet stops after passing through a certain number of hops and the task of forwarding the multicast packet fails so the switch controller 102 provides the indication of the number of hops that are traversed by the multicast packet before failing. The indication is included in the header that is sent back to the sender 104. In an example, the multicast packet is forwarded from the one or more ports 106 and after passing through five hops, the multicast packet stops and the task of forwarding the multicast packet fails-then the switch controller 102 truncates the header of the multicast packet. Further, the switch controller 102 provides the indication in the header about the five hops that are traversed by the corresponding multicast packet before sending the header back to the sender 104.

In accordance with an embodiment, the switch controller 102 is further configured to set the header-forwarding bit in the header before sending the header to the sender 104, to indicate that the header is a failed multicast packet header. The header-forwarding bit is set in the header by the switch controller 102 for not only notifying the switch controller 102 to send back the header when the at least one of the one or ports 106 fails in forwarding the multicast packet, but also to indicate the sender 104 that the received header is of the failed multicast packet. For example, in a scenario where the multicast packet forwarded by the switch controller 102 has failed to get further forwarded from the at least one of the one or more ports 106 then the switch controller 102 sets the header-forwarding bit in the header, and sends the header of the failed multicast packet back to the sender 104 respectively. Further, the sender 104 receives the header with the set header-forwarding bit which notifies the sender 104 that the received header is of the failed multicast packet.

In accordance with an embodiment, the switch controller 102 is further configured to determine that a second header-forwarding bit is set, and if so, attempt to send the header through the failed port. The second header-forwarding bit is set in the header is determined by the switch controller 102. In this scenario, if the multicast packet fails to get forwarded from the at least one of the one or more ports 106, then the switch controller 102 truncates the header of the failed multicast packet and sends the truncated header to the receiver from the corresponding port which has failed in forwarding the multicast packet. After the header is forwarded to the receiver, and in response to this, the receiver sends a negative acknowledgment (NACK) message to the sender 104. Moreover, the switch controller 102 sends the header to the receiver through the failed port after the analysis performed by the sender 104 about the number of failed ports. If the number of failed ports is less than the NACK messages received each corresponding receiver may receive a unicast packet transmitted by the sender 104.

Thus, the switch controller 102 prevents a storm of negative acknowledgement messages at the sender 104 by virtue of sending back merely the header of the multicast packet to the sender 104 which helps in saving of network bandwidth and reducing the network load at the sender 104. Moreover, the switch controller 102 helps in reducing the consumption of processing power of the sender 104. Furthermore, the switch controller 102 provides a significant reduction in the end-to-end latency in communication of the multicast packet.

FIG. 2 is a block diagram that illustrates various exemplary components of a switch controller, in accordance with an embodiment of the present disclosure. FIG. 2 is described in conjunction with elements from FIG. 1. With reference to FIG. 2, there is shown a block diagram 200 of the switch controller 102. The switch controller 102 includes a network interface card 202, a memory 204, and a processor 206.

The network interface card 202 may include suitable logic, circuitry, and/or interfaces that is configured to communicate with the sender 104, and the one or more ports 106 of FIG. 1. The network interface card 202 may also be referred to as a network interface. Examples of the network interface card 202 include, but are not limited to, a data terminal, a transceiver, a facsimile machine, a virtual server, and the like.

The memory 204 may include suitable logic, circuitry, and/or interfaces that is configured to store information (or a multicast packet) required to be communicated by the sender 104. In an implementation, the memory 204 may also be configured to store data and instructions executable by the processor 206. Examples of implementation of the memory 204 may include, but are not limited to. Electrically Erasable Programmable Read-Only Memory (EEPROM). Dynamic Random-Access Memory (DRAM). Random Access Memory (RAM). Read-Only Memory (ROM). Hard Disk Drive (HDD). Flash memory, a Secure Digital (SD) card. Solid-State Drive (SSD), and/or CPU cache memory. The memory 204 may store an operating system or other program products (including one or more operation algorithms) to operate the switch controller 102.

The processor 206 may include suitable logic, circuitry, interfaces, or code that is configured to execute the instructions stored in the memory 204. In an implementation, the operations executed by the switch controller 102 may be executed and controlled by the processor 206. Examples of the processor 206 may include, but are not limited to, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuitry. Moreover, the processor 206 may refer to one or more individual processors, processing devices, a processing unit that is part of a machine, such as the switch controller 102.

The switch controller 102 is connected to the sender 104 through the network interface card 202. Alternatively stated, the switch controller 102 receives a multicast packet from the sender 104 through the network interface card 202. The multicast packet may be stored in the memory 204 of the switch controller 102, after being received from the sender 104. In an implementation, the memory 204 may reside outside the network interface card 202. In another implementation, the memory 204 may reside inside the network interface card 202. Further, the switch controller 102 transfer the corresponding multicast packet to multiple receivers. The operations to transfer the corresponding multicast packet to the one or more ports 106 may be controlled by the processor 206. The processor 206 may lie inside or outside the network interface card 202. Further, the switch controller 102 also provides an acknowledgement to the sender 104 if the multicast packet fails to reach a receiver by sending a header to the sender 104.

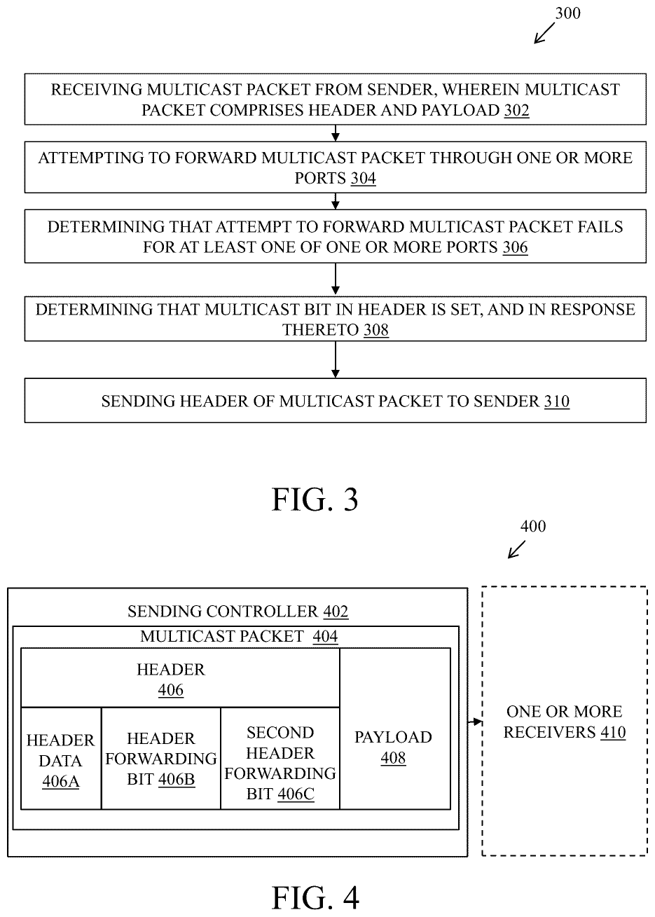

FIG. 3 is a flow chart of a method for use in a switch controller, in accordance with an embodiment of the present disclosure. FIG. 3 is described in conjunction with elements from FIG. 1, and FIG. 2. With reference to FIG. 3, there is shown a flowchart of a method 300 that includes steps 302 to 310. The switch controller 102 (of FIG. 1) is configured to execute the method 300.

There is provided the method 300 for use in the switch controller 102. The method 300 provides an improved reliable multicast protocol to prevent from storm of negative acknowledgment (NACK) messages to occur at the sender 104 upon failure of the multicast packet from reaching the destination. In the method 300, a header of the multicast packet is sent back to the sender 104 upon failure of the multicast packet. In other words, the header of failed multicast packet is truncated and sent back to the sender 104 for preventing the sender 104 from receiving multiple NACK messages.

At step 302, the method 300 includes, receiving a multicast packet from the sender 104, where the multicast packet includes a header and a payload. The multicast packet is received by the switch controller 102 from the sender 104 to forward the corresponding multicast packet to the multiple receivers through the one or more ports 106. For example, to send the multicast packet to the multiple receivers, the sender 104 firstly forwards the multicast packet to the switch controller 102, then the corresponding multicast packet is transferred to the receivers by the switch controller 102 through the one or more ports 106. The header disclosed in the method 300 is a detachable part that can be used for acknowledgment purpose and the payload contains the main information which is required to be sent to the multiple receivers.

At step 304, the method 300 includes, attempting to forward the multicast packet through one or more ports 106. After receiving the multicast packet, the switch controller 102 forwards the multicast packet to the multiple receivers through the one or more ports 106. For example, to send the multicast packet to the multiple receivers, the switch controller 102 firstly forwards the multicast packet to the one or more ports 106, then the corresponding multicast packet is transferred to the multiple receivers.

At step 306, the method 300 includes, determining that the attempt to forward the multicast packet fails for at least one of the one or more ports. In an example, the multicast packet is forwarded by the switch controller 102 to the multiple receivers through the one or more ports 106 and the task of forwarding the multicast packet fails for at least one of the one or more ports 106, then the switch controller 102 acts according to the situation.

At step 308, the method 300 includes, determining that a header-forwarding bit in the header is set in response to the failure in forwarding the multicast packet. In case of failure in forwarding the multicast packet to the at least one of the multiple receivers, the switch controller 102 is configured to determine that the header-forwarding bit is set or not in the header. Further, the header-forwarding bit is stored with an instruction which is followed by the switch controller 102 upon the failure in forwarding the multicast packet.

At step 310, the method 300 includes, sending the header of the multicast packet to the sender 104 in response to the determining of the header-forwarding bit is set in the header. For example, the multicast packet forwarded by the switch controller 102 is failed to reach to reach one of the multiple receivers through the at least one of the one or more ports 106 then the switch controller 102 follows the instruction stored in the header-forwarding bit, and sends the header of the failed multicast packet back to the sender 104, respectively. Further, the sender 104 receives the header that notifies the sender 104 about failure of the task of forwarding the multicast packet to the at least one of the multiple receivers.

In accordance with an embodiment, method 300 further includes, determining which port failed and including an indication of this port in the header before sending the header to the sender 104. The multicast packet is forwarded from the one or more ports 106 and the first port 106A fails to forward the multicast packet then, the switch controller 102 is configured to truncate the header of the multicast packet which is forwarded from the first port 106A. Further, the switch controller 102 provides the indication in the header about the first port 106A to notify the sender 104 that the first port 106A fails to forward the multicast packet.

In accordance with an embodiment, method 300 further includes, determining a number of how many ports failed and include an indication of corresponding number of failed ports in the header before sending the header to the sender 104. For example, if the multicast packet is forwarded from the one or more ports 106 and ten ports failed to forward the multicast packet, then the switch controller 102 truncates the header of the multicast packet which is forwarded from the corresponding ten ports. Further, the switch controller 102 provides the indication in the headers about the corresponding ten ports which failed to forward the multicast packet and sends the respective headers to the sender 104.

In accordance with an embodiment, method 300 further includes, determining a number of hops traversed by the received multicast packet and including an indication of this number of hops in the header before sending the header to the sender 104. For example, if the multicast packet stops after passing through a certain number of hops and the task of forwarding the multicast packet fails, the switch controller 102 provides the indication of the number of hops that are traversed by the multicast packet before failing. The indication is included in the header that is sent back to the sender 104. In an example, the multicast packet is forwarded from the one or more ports 106 and after passing through five hops, the multicast packet stops and the task of forwarding the multicast packet fails, then the switch controller 102 truncates the header of the multicast packet. Further, the switch controller 102 provides the indication in the headers about the five hops that are traversed by the corresponding multicast packet before sending the header to the sender 104.

In accordance with an embodiment, method 300 further includes, setting the header-forwarding bit in the header before sending the header to the sender indicating that the header is a failed multicast packet header. The header-forwarding bit is set in the header by the switch controller 102 for not only notifying the switch controller 102 to send back the header when the at least one of the one or more ports 106 fails in forwarding the multicast packet, but also to indicate to the sender 104 that the received header is of the failed multicast packet.

In accordance with an embodiment, method 300 further includes, determining that a second header-forwarding bit is set, and if so, attempt to send the header through the failed port. The second header-forwarding bit being set in the header is determined by the switch controller 102. In this scenario, if the multicast packet fails to get forwarded from the at least one of the one or more ports 106, then the switch controller 102 truncates the header of the failed multicast packet and sends the truncated header to the receiver from the corresponding port which is failed in forwarding the multicast packet. After the header is forwarded to the receiver, and in response to this, the receiver sends a negative acknowledgment (NACK) message to the sender 104. In such a case, each corresponding receiver may receive a unicast packet transmitted by the sender 104.

The sender 104 is protected from the storm of NACK massages by using the method 300 in the reliable multicast protocol. The switch controller 102 in the method 300 sends the multicast packet to multiple receivers, so the sender 104 sends the multicast packet only to the switch controller 102 for providing the multicast packet to the multiple receivers. Further, the multicast packet comprises the header and the payload. The payload carries the information stored in the multicast packet and the header is an attachment of the multicast packet, the header is detached according to requirements. Further, the switch controller 102 attempts to forward the multicast packet through the one or more ports 106 for sending the multicast packet to the multiple receivers. The one or more ports 106 provide a path to the multicast packet in reaching the receivers. Further, if the header-forwarding bit in the header is set this notifies the switch controller 102 to send the header back to the sender 104 upon failure of the attempt to forward the multicast packet for the at least one of the one or more ports 106. The header is sent back to the sender 104 for providing acknowledgement to the sender 104 that the attempt to forward the multicast packet has failed for the at least one of the one or more ports 106, thus preventing the sender 104 from a storm of the NACK messages which helps in protecting a path of the sender 104 from network congestion and reduces processing power consumption of the sender 104.

The steps 302 to 310 are only illustrative, and other alternatives can also be provided where one or more steps are added, one or more steps are removed, or one or more steps are provided in a different sequence without departing from the scope of the claims herein.

FIG. 4 is a block diagram of a sending controller, in accordance with an embodiment of the present disclosure. FIG. 4 is described in conjunction with elements of FIGS. 1 and 2. With reference to FIG. 4, there is shown a block diagram 400 of a sending controller 402. The sending controller 402 is configured to generate a multicast packet 404. The multicast packet 404 includes a header 406 and a payload 408. The header 406 includes a header data 406A, a header-forwarding bit 406B, and a second header-forwarding bit 406C. There is further shown one or more receivers 410.

The sending controller 402 is configured to generate the multicast packet 404 that includes the information in terms of the header 406 and the payload 408 which is to be transmitted to the one or more receivers 410. Further, the sending controller 402 firstly forwards the multicast packet 404 to the switch controller 102 (of FIG. 1) for providing the multicast packet 404 to each receiver of the one or more receivers 410.

The header 406 is the detachable part of the multicast packet 404 that is used for acknowledgment purpose. The header 406 is received by the sending controller 402 when the multicast packet 404 fails to reach the respective destination.

In operation the sending controller 402 is configured to generate the multicast packet 404, comprising the header 406 and the payload 408. The multicast packet 404 is generated by the sending controller 402 to forward the corresponding multicast packet 404 to the one or more receivers 410. Further, the multicast packet 404 is divided in two parts, one is the header 406, and another is the payload 408. The header 406 is the detachable part that is used for acknowledgment purpose and the payload 408 contains the main information which is required to send to the one or more receivers 410. For example, if information is required to send to the one or more receivers 410 then it becomes quite time consuming to send the information separately to each of the one or more receivers 410 so the sending controller 402 generates the multicast packet 404 which can be delivered to the one or more receivers 410 at the same time. Moreover, the multicast packet generated by the sending controller 402 has the header 406 and the payload 408. The header 406 can be detached from the multicast packet 404 as per the requirement and the header 406 also includes the header data 406A. In an implementation, the header data 406A can hold address of the destination where the multicast packet 404 is required to be forwarded. Further, the information that is required to be sent through the multicast packet 404 is carried by the payload 408.

The sending controller 402 is configured to set the header-forwarding bit 406B in the header 406. The header-forwarding bit 406B is set in the header 406 by the sending controller 402. The header-forwarding bit 406B is used to notify the switch controller 102 to transmit the header 406 to the sending controller 402 when the multicast packet 404 fails in reaching at least one of the one or more receivers 410. Further, the header-forwarding bit 406B indicates to the sending controller 402 that the received header 406 is of the failed multicast packet 404. For example, if the multicast packet 404 generated by the sending controller 402 has failed to reach at least one of the one or more receivers 410 then the header-forwarding bit 406B notifies the switch controller 102 to send the header 406 of the failed multicast packet 404 back to the sending controller 402 respectively. Further, the header-forwarding bit 406B also notifies to the sending controller 402 that the received header 406 is of a failed multicast packet 404. Moreover, the sending controller 402 sends the multicast packet 404 from a first path and receives the header 406 from a second path. In embodiments, the first path is not same as the second path.

The sending controller 402 is configured to transmit the multicast packet 404. The multicast packet 404 is transmitted by the sending controller 402 to the one or more receivers 410. For example, to share the information with the one or more receivers 410 at the same time, the sending controller 402 transmits the multicast packet 404 to the one or more receivers 410. If the multicast packet 404 fails to deliver, then the header 406 of the multicast packet 404 returns to the sending controller 402 by the header-forwarding bit 406B.

In accordance with an embodiment, the sending controller 402 is further configured to receive the header 406 as a response. The header 406 is received by the sending controller 402 when forwarding of the multicast packet 404 fails. For example, if the multicast packet 404 forwarded by the sending controller 402 has failed to reach the at least one of the one or more receivers 410, then the header-forwarding bit 406B is set in the header 406 to notify the switch controller 102 to send back the header 406 to the sending controller 402. In an implementation, there may be one or more switch controllers to send one or more headers to one or more sending controllers upon failure of multiple multicast packets to reach the one or more receivers 410. This further prevents a storm of one or more NACK messages being provided to the one or more sending controllers.

In accordance with an embodiment, the sending controller 402 is further configured, in response to receiving the header 406, to determine that the multicast transmission has failed. The header 406 received by the sending controller 402 indicates that the multicast packet 404 has failed to reach the at least one of the one or more receivers 410. For example, the multicast packet 404 sent by the sending controller 402 fails to deliver at the one or more receivers 410, then the header 406 is truncated from the failed multicast packet 404 and sent back to the sending controller 402 for notifying that the transmission of the multicast packet 404 has failed.

In accordance with an embodiment, the sending controller 402 is further configured to retransmit the multicast packet 404 as a multicast. In response of the failure of first attempt to send the multicast packet 404 to the one or more receivers 410, the sending controller 402 receives the header 406 and performs another attempt to transmit the multicast packet 404 to the one or more receivers 410.

In accordance with an embodiment, the sending controller 402 is further configured to receive the header 406 as a response. For example, if another attempt of transmitting the multicast packet 404 fails, then again, the header 406 is received by the sending controller 402. The received header 406 helps in determining that the multicast packet 404 has failed to reach the at least one of the one or more receivers 410 also in the second attempt. For example, the multicast packet 404 sent by the sending controller 402 fails to deliver at the at least one of the one or more receivers 410 in the second attempt, then the header 406 is again truncated from the failed multicast packet 404 and sent back to the sending controller 402 for notifying that the transmission of the multicast packet 404 has failed again in the second attempt.

In accordance with an embodiment, the sending controller 402 is further configured to receive one or more NACK-messages from corresponding receivers. After the failure in forwarding the multicast packet 404 in the second attempt, the one or more receivers 412 sends the one or more NACK-messages to the sending controller 402. The one or more NACK-messages received from the one or more receivers 410 notify the sending controller 402 that the corresponding receivers have not received the multicast packet 404.

In accordance with an embodiment, the sending controller 402 is further configured to retransmit the multicast packet 404 as a unicast packet to each of the corresponding receivers. After receiving the NACK-messages from the corresponding receivers, the sending controller 402 retransmits the multicast packet 404 as the unicast packet to each of the one or more receivers 410. For example, if the second attempt to transmit the multicast packet 404 fails, then the sending controller 402 receives the header 406 again, and also receives the NACK-messages from the one or more receivers 410. Further, the sending controller 402 retransmits the information but by using the unicast packet instead of the multicast packet 404.

In accordance with an embodiment, the sending controller 402 is further configured to retransmit the multicast packet 404 as a multicast, setting the second header-forwarding bit 406C in the header 406. The second header-forwarding bit 406C is set with the header 406 by the sending controller 402 before performing retransmission of the multicast packet 404. The second header-forwarding bit 406C is also a part of the header 406 which carries instruction of sending the header 406 to the destination.

In accordance with an embodiment, the sending controller 402 is further configured to receive the header 406 as a response. For example, if another attempt of transmitting the multicast packet 404 fails, then the header 406 is received by the sending controller 402. The received header 406 helps in determining that the multicast packet 404 has failed to reach the one or more receivers 410 also in the second attempt. For example, the multicast packet 404 sent by the sending controller 402 fails to deliver at the one or more receivers 410 in the second attempt, then the header 406 is again truncated from the failed multicast packet 404 and sent to the sending controller 402 by the second header-forwarding bit 406C for notifying that the transmission of the multicast packet 404 has failed again in the second attempt.

In accordance with an embodiment, the sending controller 402 is further configured to receive one or more NACK-messages from corresponding receivers. After the failure of a second attempt, the second header-forwarding bit 406C notifies the switch controller 102 to send the header 406 to the one or more receivers 410. Moreover, the switch controller 102 sends the header 406 to the corresponding receivers. The sending controller 402 allows to send the header 406 to the corresponding receivers after analysing that the number of NACK messages will be less. By forwarding the header 406, the acknowledgment is provided to the corresponding receivers about the failed attempt of forwarding the multicast packet 404 and the corresponding receivers send NACK messages to the sending controller 402.

In accordance with an embodiment, the sending controller 402 is further configured to retransmit the multicast packet 404 as a unicast packet to each of the corresponding receivers. After receiving the NACK-messages from the corresponding receivers, the sending controller 402 retransmits the unicast packet to each of the corresponding receivers separately. For example, the second attempt to transmit the multicast packet 404 fails then the sending controller 402 receives the header 406 again, and also receives the NACK-messages from the corresponding receivers. Further, the sending controller 402 retransmits the information but by using the unicast packet instead of the multicast packet 404.

Thus, the sending controller 402 helps in making the task easier of transmitting multicast packet 404 by retrying the transmission of the multicast packet 404 after the failing in first attempt. Moreover, the sending controller 402 analyses the number of NACK messages before allowing the second header-forwarding bit 406C to send the header 406 to the corresponding receivers after the failure of second attempt. Furthermore, the sending controller 402 helps in forwarding the multicast packet 404 as unicast after the failure of second attempt.

FIG. 5 is a block diagram that illustrates various exemplary components of a sender, in accordance with an embodiment of the present disclosure. FIG. 5 is described in conjunction with elements from FIG. 1 and FIG. 4. With reference to FIG. 5, there is shown a block diagram 500 of the sender 104 that includes a memory 502, a network interface card 504. The network interface card 504 comprises the sending controller 402 (of FIG. 4).

The memory 502 may include suitable logic, circuitry, and/or interfaces that is configured to store the multicast packet 404 generated by the sending controller 402. In an implementation, the memory 502 may be configured to store data and instructions executable by the sending controller 402. Examples of implementation of the memory 502 may include, but are not limited to, Electrically Erasable Programmable Read-Only Memory (EEPROM). Dynamic Random-Access Memory (DRAM). Random Access Memory (RAM). Read-Only Memory (ROM). Hard Disk Drive (HDD). Flash memory, a Secure Digital (SD) card. Solid-State Drive (SSD), and/or CPU cache memory. The memory 502 may store an operating system or other program products (including one or more operation algorithms) to operate the sender 104.

The network interface card 504 may include suitable logic, circuitry, and/or interfaces that is configured to communicate with the components like sender 104, one or more ports 106 of FIG. 1, sending controller 402, and one or more receivers 412 of FIG. 4. The network interface card 504 may also be referred to as a network interface. Examples of the network interface card 504 include, but are not limited to, a data terminal, a transceiver, a facsimile machine, a virtual server, and the like.

The sender 104 is connected to the switch controller 102 through the network interface card 504. Further, the sender 104 generates the multicast packet 404 using the sending controller 402 and transmits to the switch controller 102 through the network interface card 504. The operations to generate and transfer the corresponding multicast packet 404 are controlled by the sending controller 402. The multicast packet 404 may be stored in the memory 502 of the sender 104. In an implementation, the memory 502 may reside outside the network interface card 504. In another implementation, the memory 502 may reside inside the network interface card 504. Further, the sender 104 transfer the corresponding multicast packet 404 to multiple receivers. The operations to transfer the corresponding multicast packet 404 may control by the sending controller 402. In an implementation, the sending controller 402 may reside outside the network interface card 504. In another implementation, the sending controller 402 may reside inside the network interface card 504.

FIG. 6 is a flow chart of a method for use in a sending controller, in accordance with an embodiment of the present disclosure. FIG. 6 is described in conjunction with elements from FIGS. 4 and 5. With reference to FIG. 6, there is shown a flowchart of method 600 that includes steps 602 to 606. The sending controller 402 is configured to execute the method 600.

There is provided the method 600 for use in the sending controller 402. The method 600 provides an improved reliable multicast protocol to prevent the sending controller 402 from a storm of negative acknowledgment (NACK) messages upon the failure of multicast packet 404 from reaching the destination. In this method 600 a header 406 of the multicast packet 404 is truncated and sent back to the sending controller 402 upon failure of the multicast packet 404. In other words, the header 406 of failed multicast packet 404 is truncated and sent to the sending controller 402 for preventing the sending controller 402 from receiving multiple NACK messages.

At step 602, the method 600 includes, generating the multicast packet 404, comprising the header 406 and a payload 408. The multicast packet 404 is generated by the sending controller 402 to forward the corresponding multicast packet 404 to the one or more receivers 410. Further, the multicast packet 404 is divided in two parts, one is the header 406, and another is the payload 408. The header 406 is the detachable part that is used for acknowledgment purpose and the payload 408 contains the main information which is needed to be sent to the multiple receivers. Moreover, the multicast packet 404 generated by the sending controller 402 has the header 406 and the payload 408. The header 406 can be detached from the multicast packet 404 as per the requirement and the header 406 also includes the header data 406A. Further, the information that is to be sent through the multicast packet 404 is carried by the payload 408.

At step 604, the method 600 includes, setting the header-forwarding bit 406B in the header 406. The header-forwarding bit 406B is set with the header 406 by the sending controller 402. The header-forwarding bit 406B is used to notify the switch controller 102 to transmit the header 406 to the sending controller 402 when the multicast packet 404 fails in reaching the one or more receivers 410. Further, the header-forwarding bit 406B indicates the sending controller 402 that the received header 406 is of the failed multicast packet 404.

At step 606, the method 600 includes, transmitting the multicast packet 404. For example, to share the information with the one or more receivers 412 at the same time, the sending controller 402 transmits the multicast packet 404 to the one or more receivers 410. If the multicast packet 404 fails to deliver, then the header 406 of the multicast packet 404 returns to the sending controller 402 by the header-forwarding bit 406B.

In accordance with an embodiment, method 600 further includes receiving the header 406 as a response. The header 406 is received by the sending controller 402 when the forwarding of multicast packet 404 fails. The header-forwarding bit 406B notifies that the header 406 of the failed multicast packet 404 is required to send back to the sending controller 402 after the failure of forwarding the multicast packet 404.

In accordance with an embodiment, method 600 further includes determining that the multicast transmission has failed. After failure of forwarding the multicast packet 404, the header 406 is truncated from the failed multicast packet 404 and sent back to the sending controller 402 for notifying that the transmission of the multicast packet 404 is failed.

In accordance with an embodiment, method 600 further includes, retransmitting the multicast packet 404 as a multicast. The sending controller 402 receives the header 406 after the failure of first attempt to send the multicast packet 404 to the one or more receivers 410 and, in response to this, performs another attempt to transmit the multicast packet 404 to the one or more receivers 410.

In accordance with an embodiment, method 600 further includes, receiving the header 404 as a response. For example, if another attempt of transmitting the multicast packet 404 fails then, the header 406 is received by the sending controller 402. The received header 406 provides an acknowledgment to the sending controller 402 that the multicast packet 404 has failed to reach the one or more receivers 412 also in the second attempt.

In accordance with an embodiment, method 600 further includes, receiving one or more NACK-messages from corresponding receivers. After the failure in forwarding the multicast packet 404, also in the second attempt, the one or more receivers 412 sends the one or more NACK-messages to the sending controller 402 to notify the sending controller 402 that the corresponding receivers have not received the multicast packet 404.

In accordance with an embodiment, method 600 further includes, retransmitting the multicast packet 404 as a unicast packet to each of the corresponding receivers. For example, the second attempt to transmit the multicast packet 404 fails then the sending controller 402 receives the header 406 again, and also receives the NACK-messages from the corresponding receivers. Further, the sending controller 402 retransmits the information but by using the unicast packet instead of the multicast packet 404.

In accordance with an embodiment, method 600 further includes, retransmitting the multicast packet 404 as a multicast, setting a second header-forwarding bit 406C in the header 406. The second header-forwarding bit 404C is also a part of the header 406 which carries instruction of sending the header 406 to the destination. The sending controller 402 sets the second header-forwarding bit 406C in the header 406.

In accordance with an embodiment, method 600 further includes, receiving the header as a response. For example, if another attempt of transmitting the multicast packet 404 fails then also the header 406 is received by the sending controller 402. The received header 406 helps in determining that the multicast packet 404 has failed to reach the one or more receivers 412 in the second attempt.

In accordance with an embodiment, method 600 further includes, receiving one or more NACK-messages from corresponding receivers. The switch controller 102 sends the header 406 to the corresponding receivers upon being notified by the second header-forwarding bit 406C. The sending controller 402 allows sending the header 406 to the corresponding receivers after analysing that the number of NACK messages will be less. By forwarding the header 406, the acknowledgment is provided to the corresponding receivers about the failed attempt of forwarding the multicast packet 404 and the corresponding receivers sent NACK messages to the sending controller 402.

In accordance with an embodiment, method 600 further includes, retransmitting the multicast packet 404 as a unicast packet to each of the corresponding receivers. After the failure of second attempt to transmit the multicast packet 404 fails then the sending controller 402 receives the header 406 again and also receives the NACK-messages from the corresponding receivers. Further the sending controller 402 retransmits the information but by using the unicast packet instead of the multicast packet.

The method 600 provides improvements of preventing the sending controller 402 from receiving a storm of NACKs massages in the reliable multicast protocol. The sending controller 402 in the method 600 sends the multicast packet 404 to the one or more receivers 412. Further, the multicast packet 404 comprises the header 406 and the payload 408. The payload 408 carries the information stored in the multicast packet 404 and the header 406 is an attachment of the multicast packet 404, the header 406 is detached according to the requirement. Further, the sending controller 402 attempt to forward the multicast packet 404 to the one or more receivers 412. Further, the header-forwarding bit 406B in the header 406 is set to send the header 406 back to the sending controller 402 upon the attempt to forward the multicast packet 404 fails. The header 406 is sent back to the sending controller 402 for providing acknowledgement to the sending controller 402 that the attempt to forward the multicast packet 404 is failed, thus preventing the sending controller 402 from NACK messages. This further results in the saving of network bandwidth and reducing the network load at the sender. Moreover, due to prevention of the storm of negative acknowledgement messages at the sender 104, the consumption of the sender's processing power is significantly reduced. Additionally, the end-to-end latency in communication of the multicast packet 404 is significantly reduced.

The steps 602 to 606 are only illustrative, and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including,” “comprising,” “incorporating,” “have,” and/or “is” are used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration.” Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments.” It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A switch controller, the switch controller comprising a processor, wherein the switch controller is configured to:
receive a multicast packet from a sender, wherein the multicast packet comprises a header and a payload;
attempt to forward the multicast packet through one or more ports;
determine that the attempt to forward the multicast packet through one or more ports fails for at least one of the one or more ports, and in response thereto:
determine that a header-forwarding bit in the header is set, and in response thereto: send the header of the multicast packet to the sender.

2. The switch controller according to claim 1, wherein the switch controller is further configured to:
determine which port of the one or more ports failed; and
include an indication of the port in the header before sending the header to the sender.

3. The switch controller according to claim 1, wherein the switch controller is further configured to:
determine a number of how many ports of the one or more ports failed; and
include an indication of the number of failed ports in the header before sending the header to the sender.

4. The switch controller according to claim 1, wherein the switch controller is further configured to:
determine a number of hops traversed by the received multicast packet; and
include an indication of the number of hops in the header before sending the header to the sender.

5. The switch controller according to claim 1, wherein the switch controller is further configured to set the header-forwarding bit in the header before sending the header to the sender to indicate that the header is a failed multicast packet header.

6. The switch controller according to claim 1, wherein the switch controller is further configured to attempt to send the header through the failed port in response to determining that a second header-forwarding bit is set.

7. A sending controller, the sending controller comprising a processor, wherein the sending controller is configured to:
generate a multicast packet, the multicast packet comprising a header and a payload;
set a header-forwarding bit in the header; and
transmit the multicast packet.

8. The sending controller according to claim 7, wherein the sending controller is further configured to:
receive the header as a response; and
determine that a multicast transmission failed.

9. The sending controller according to claim 7, wherein the sending controller is further configured to:
retransmit the multicast packet as a multicast;
receive the header as a response;
receive one or more negative acknowledgment messages from corresponding receivers; and
retransmit the multicast packet as a unicast packet to each of the corresponding receivers.

10. The sending controller according to claim 7, wherein the sending controller is further configured to:
retransmit the multicast packet as a multicast; and setting a second header-forwarding bit in the header;
receive the header as a response;
receive one or more negative acknowledgment messages from corresponding receivers; and
retransmit the multicast packet as a unicast packet to each of the corresponding receivers.

11. A method comprising:
receiving, by a switch controller, a multicast packet from a sender, wherein the multicast packet comprises a header and a payload;
attempting, by the switch controller, to forward the multicast packet through one or more ports;
determining, by the switch controller, that the attempt to forward the multicast packet through one or more ports fails for at least one of the one or more ports, and in response thereto:
determining, by the switch controller, that a header-forwarding bit in the header is set, and in response thereto: sending, by the switch controller, the header of the multicast packet to the sender.

12. The method according to claim 11, further comprising:
determining, by the switch controller, which port of the one or more ports failed; and
including, by the switch controller, an indication of the port in the header before sending the header to the sender.

13. The method according to claim 11, further comprising:
determining, by the switch controller, a number of how many ports of the one or more ports failed; and
including, by the switch controller, an indication of the number of failed ports in the header before sending the header to the sender.

14. The method according to claim 11, further comprising:
determining, by the switch controller, a number of hops traversed by the received multicast packet; and
including, by the switch controller, an indication of the number of hops in the header before sending the header to the sender.

15. The method according to claim 11, further comprising setting, by the switch controller, the header-forwarding bit in the header before sending the header to the sender indicating that the header is a failed multicast packet header.

16. The method according to claim 11, further comprising attempting, by the switch controller, to send the header through the failed port in response to determining that a second header-forwarding bit is set.

17. A method comprising:
generating, by a sending controller, a multicast packet, the multicast packet comprising a header and a payload;
setting, by the sending controller, a header-forwarding bit in the header; and
transmitting, by the sending controller, the multicast packet.

18. The method according to claim 17, further comprising:
receiving, by the sending controller, the header as a response; and
determining, by the sending controller, that a multicast transmission failed.

19. The method according to claim 17, further comprising:
retransmitting, by the sending controller, the multicast packet as a multicast;
receiving, by the sending controller, the header as a response;
receiving, by the sending controller, one or more negative acknowledgment messages from corresponding receivers; and
retransmitting, by the sending controller, the multicast packet as a unicast packet to each of the corresponding receivers.

20. The method according to claim 17, further comprising:
retransmitting, by the sending controller, the multicast packet as a multicast; and
setting a second header-forwarding bit in the header;
receiving, by the sending controller, the header as a response;
receiving, by the sending controller, one or more negative acknowledgment messages from corresponding receivers; and
retransmitting, by the sending controller, the multicast packet as a unicast packet to each of the corresponding receivers.
